(19) United States
(12) Patent Application Publication
(10) Pub. No.: US 2009/0213581 A1
(43) Pub. Date: Aug. 27, 2009

(54) LIGHTING APPARATUS WITH CANDLES AND ELECTRIC LAMPS

(76) Inventor: Derek K. Gauger, Ann Arbor, MI (US)

Correspondence Address: YOUNG BASILE, 3001 WEST BIG BEAVER ROAD, SUITE 624, TROY, MI, 48084, US

(21) Appl. No.: 12/035,890

(22) Filed: Feb. 22, 2008

(51) Int. Cl. F21L 19/00; F21V 35/00

(52) U.S. Cl. 362/161; 362/392

(57) ABSTRACT

A lighting apparatus includes an electric light source and a natural light source, such as candles, oil lamps, or other flame generating devices. The lighting apparatus includes a support, a frame attached to the support, and a candleholder and an electrically powered light fixture coupled to the support or the fixture. A shelf may be coupled on the frame or the support for supporting a candle. A drip tray may be optionally associated with the candleholder.

### BACKGROUND

The present disclosure relates to lighting devices, in general, and to ceiling lights, table lamps and floor lamps having multiple lighting sources.

Chandeliers and other lighting fixtures are used to illuminate areas. Chandeliers are also used to provide ambiance, a sense of style, and a mood for the area that they are lighting. Because of this, chandeliers have been produced in a multitude of different ornamental designs as well as with different types of light sources. Because chandeliers have such a long history, they have been made with light sources including candles, gas lamps, incandescent lamps, halogen lamps, electric lamps that simulate the look of a candle, and others.

Prior chandelier and lighting fixtures designs address many of the aspects of lighting and aesthetic design desirable to consumers. Most light fixtures have a single type of light source whether in one of a multiplicity of lamps.

It is well recognized that there is a continuing need for chandeliers and other similar lighting fixtures. Additionally, it is well recognized that electric light sources and candle light sources are both desirable. Electric light sources are the most convenient and provide utility for everyday usage. Candle light sources provide a different and desirable mood. Additionally, the shape and size of a candle is desirable as there are many devices in the marketplace that simulate the look of candles but are actually electric light sources.

It would be desirable to provide a chandelier lighting fixture that has both electric light sources as well as the provision for candle light sources to be used independent of each other or simultaneously.

### SUMMARY

A lighting apparatus or fixture having two or more sources of light; one using electric power and one from candle light or other natural light sources that generate a flame. Thus, the lighting apparatus is a dual fuel lighting apparatus that is able to provide lighting convenience and quality of light.

The lighting apparatus includes a support, a candleholder coupled to the support, and an electrically powered light socket coupled to the support. A frame may be interposed between the candleholder and the light socket for coupling the candleholder and the light to the support socket. The frame may have one of a circular, polygonal, non-circular and polygonal shape. The frame may also include an outer member and an inner member coupled to the outer member and to the support. The support may include a wire passage. A shelf may be coupled to the frame or the support for supporting at least one of a candle and the candleholder. A drip tray may be coupled to the candle holder.

In one aspect, a lighting apparatus has one or a multiplicity of electrically powered light sources to provide light such as downward directed light. The lighting apparatus also has one or a multiplicity of receptacles to accept candles or other flame generating devices to provide a natural light source in addition to the electric light source. As such, the lighting apparatus provides a choice of at least two different types of lighting means to be used singularly or in combination with each other to provide convenience, quality of light, and natural light that can create a more desirable mood in the room in which the lighting apparatus is being used. The lighting apparatus is a dual fuel lighting apparatus.

In another aspect, the lighting apparatus provides the same electric powered lighting and a suitable shelf for positioning large candles and for collecting any wax drippings.

In yet another aspect, the lighting apparatus provides for either electric lighting in the up and/or down and/or sideways directions as well as candle lighting.

With a single lighting apparatus, people can enjoy two different types of light separately or together without installing conversion devices and needing to convert back and forth from electric to candle fixtures.

### BRIEF DESCRIPTION OF THE DRAWINGS

The various features, advantages and other uses of the present invention will become more apparent by referring to the following detailed description and drawing in which:

FIG. 1 is a side, elevational, and back view of a circular chandelier with candlestick holders;

FIG. 2 is a plan view of the circular chandelier with candlestick holders;

FIG. 3 is a bottom view of the circular chandelier with candlestick holders;

FIG. 4 is a perspective view of the circular chandelier with candlestick holders;

FIG. 5 is a cross section view of the lighting apparatus assembly through line A-A in FIG. 3;

FIG. 6 is a side elevational view of a square chandelier with candlestick holders;

FIG. 7 is a top plan view of the square chandelier with candlestick holders;

FIG. 8 is a bottom view of the square chandelier with candlestick holders;

FIG. 9 is a perspective view of the square chandelier with candlestick holders;

FIG. 10 is a side elevational view of a circular chandelier with integrated candle shelf;

FIG. 11 is a plan view of the circular chandelier with integrated candle shelf;

FIG. 12 is a bottom view of the circular chandelier with integrated candle shelf;

FIG. 13 is a perspective view of the circular chandelier with integrated candle shelf;

FIG. 14 is a side elevational view of the wall mount lighting apparatus with candlestick holder;

FIG. 15 is a front view of the wall mount lighting apparatus with candlestick holder;

FIG. 16 is a plan view of the wall mount lighting apparatus with candlestick holder;

FIG. 17 is a bottom view of the wall mount lighting apparatus with candlestick holder; and

FIG. 18 is a perspective view of the wall mount lighting apparatus with candlestick holder.

### DETAILED DESCRIPTION

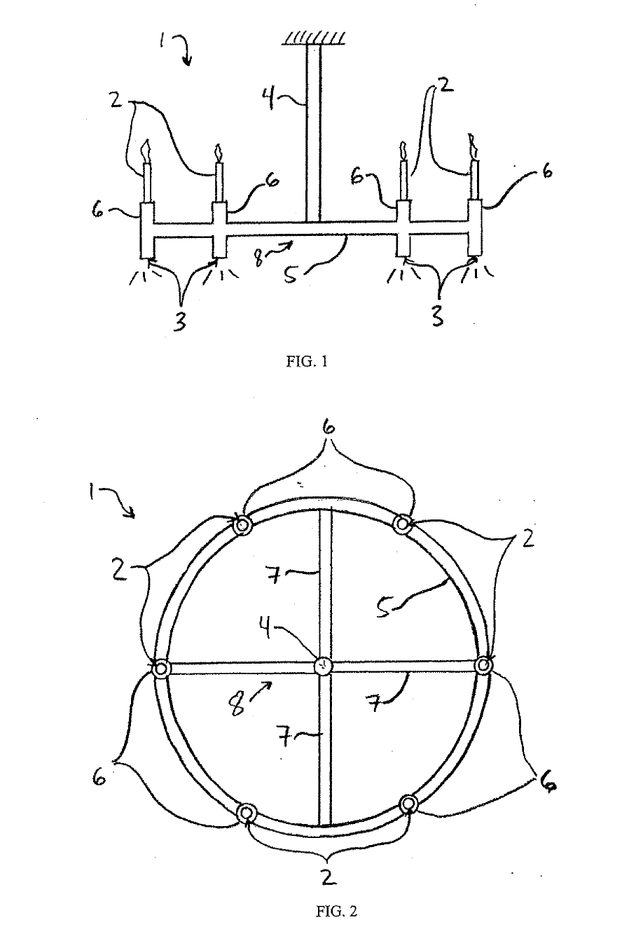

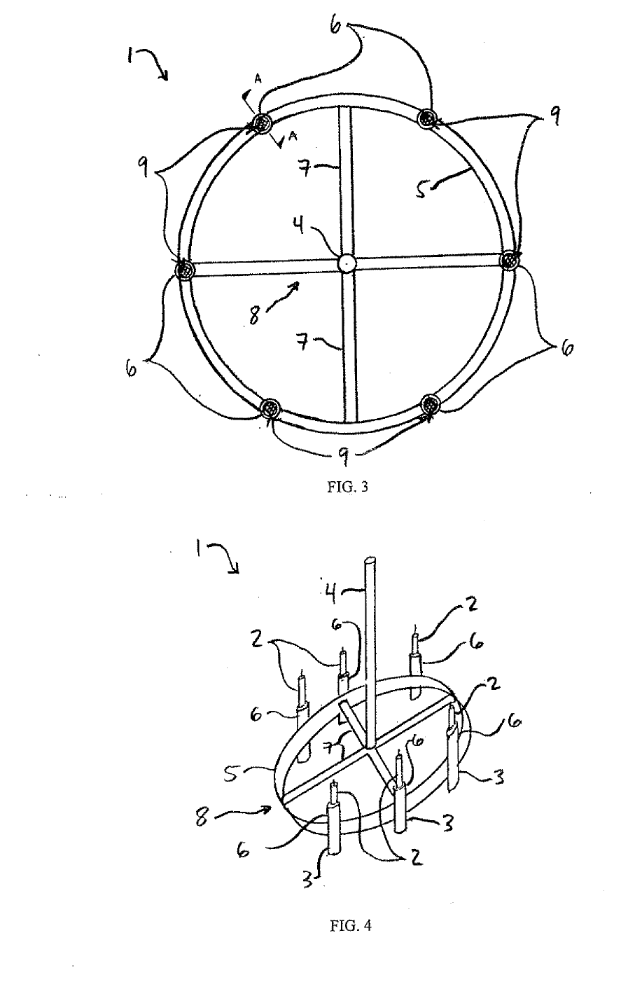

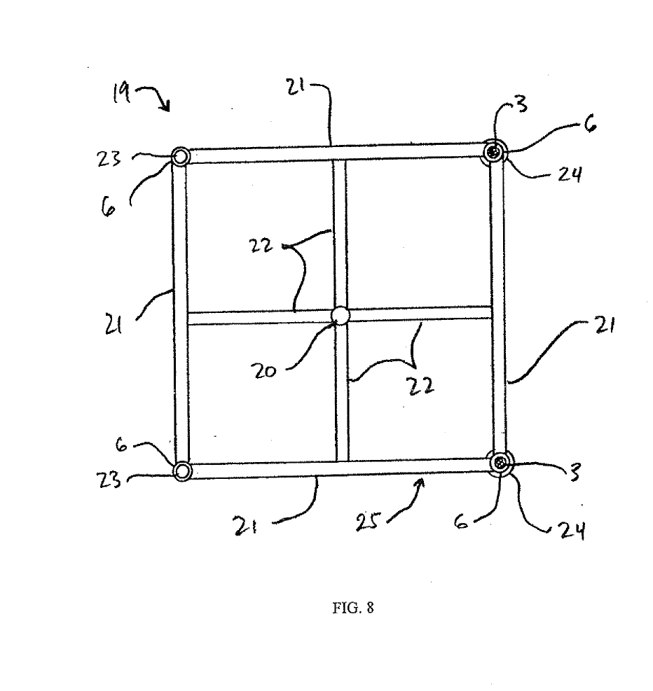

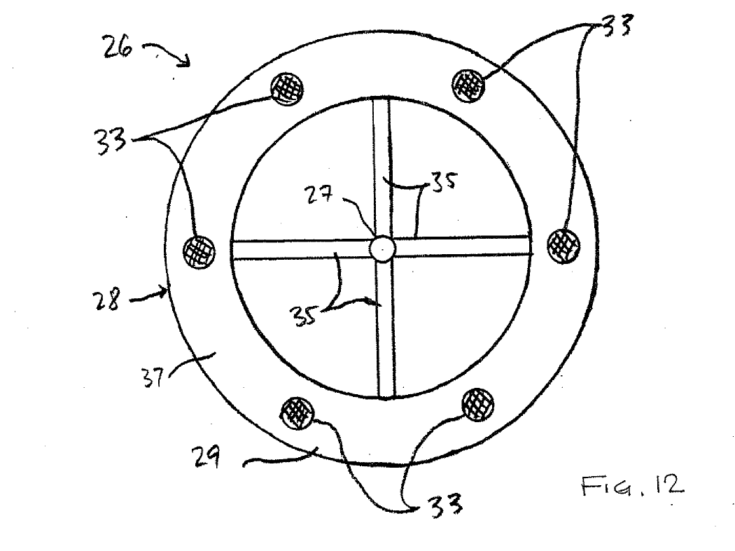

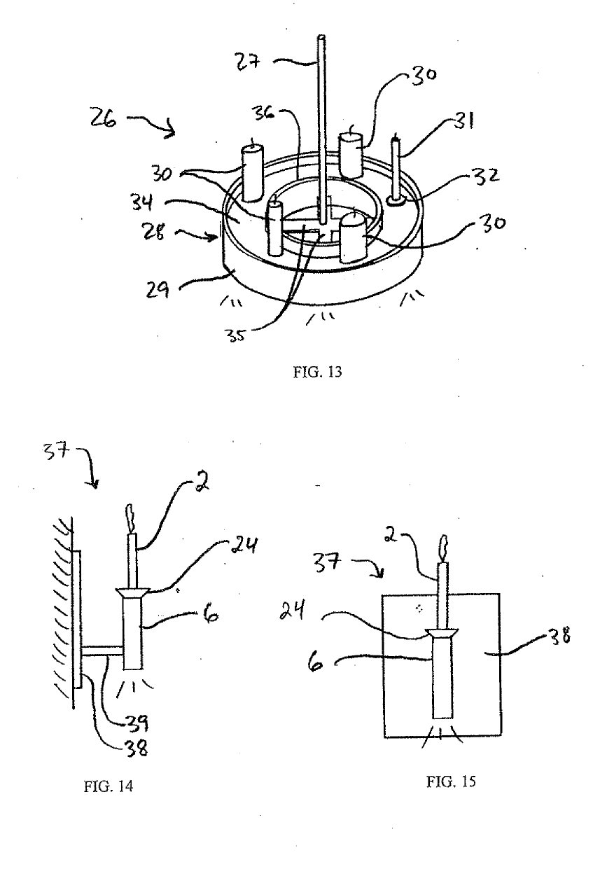

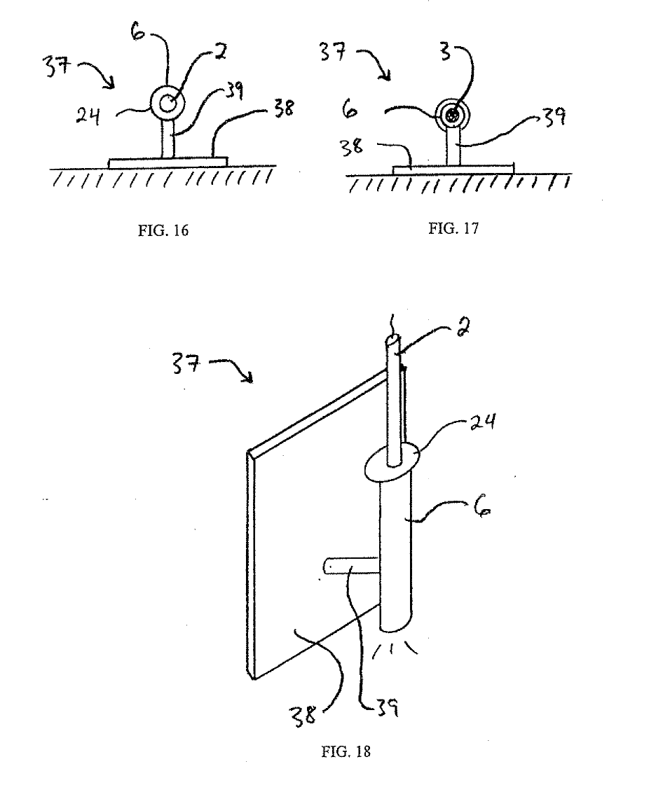

Referring to FIGS. 1 through 18 of the drawings, and to FIGS. 1-5 in particular, there is depicted a lighting apparatus shown by example only as a chandelier 1 with a lighting assembly 6 with both electric lighting means 3 and candlesticks 2 or other flame generating devices.

It will be understood that although FIGS. 1-5 describe a chandelier 1 with a particular geometry, construction, and with integrated assemblies that include both a housing 10 or receptacle for the electric lighting means 3 and the candlestick 2, there are many different geometries and construction means that could be employed. These include, but are not limited to, a variety of different sizes of candlestick holders, a different number of candlestick holders, candlestick holders that are not integrated to the electric lighting means, other flame generating devices such as liquid or gas fuel devices, a variety of different mounting and suspension means including the ability to raise and lower the lighting apparatus, different numbers of electric light fixtures including the option for a single lamp, externally mounted lighting fixtures and different types of electric light fixtures such as halogen, incandescent, fluorescent, LED, spot style lamps, flood style lamps, table and shelf and others. Additionally, there are many different materials that may be used to manufacture the components of the chandelier 1.

As shown in FIGS. 1-5, there is a support 4 for affixing the chandelier 1 to a mounting means (not shown) that would typically be attached to the ceiling surface of a room. The support 4 acts as the main mounting point or points for attaching the chandelier 1 to the mounting means. The support 4 positions the chandelier 1 in a vertical position in suspension over the area which is to be illuminated. In this aspect, these components are fabricated from tubular steel so as to provide an inner cavity or wire passage (not shown) through which the electrical wires for the electric light means are routed. One affixing means to rigidly connect these components is welding, although others are possible, such as threaded fasteners, rivets, adhesives, etc. Other configurations of the support are possible including different geometries, sizes, solid materials with external wires, and different material types including various plastics, wood, fiber materials, glass, and others. The support 4 also serves to carry the candleholders and the light fixtures.

The support 4 may be rigid, such as a tubular member with or without radially extending arms, a flexible member, such as cable, chain or rope, and combinations thereof. The support 4 can directly carry the lighting assembly 6 formed of at least one electric light source 3 and at least one candle 2. Alternately, the support 4 can include an optional main frame 8 having a generally circular outer ring 5 and a plurality of cross braces 7 that are substantially perpendicular to one another and attached to each other, the outer ring 5, and the support 4. The frame 8 can have any shape and configuration typical of chandeliers, table lamp and floor lamps, such as individual arms connected to the support 4 and carrying one or more lighting assemblies 6, arms connected to adjacent arms, tiers of arms, etc. The frame 8 and support 4 can also be integrated into a unitary structure.

Attached to and integral with the outer ring 5 are one or a multiplicity of lighting structure fixtures 6. Although in this aspect the individual components of the outer ring 5 and the lighting fixtures 6 are affixed by welding, other attachment means are possible including threaded fasteners, rivets, adhesives, etc. Each lighting assembly 6 has an electric light source 3 formed of an electric fixture or socket 15 and a light bulb 16 and a holder 18 for receiving and supporting a candle 2.

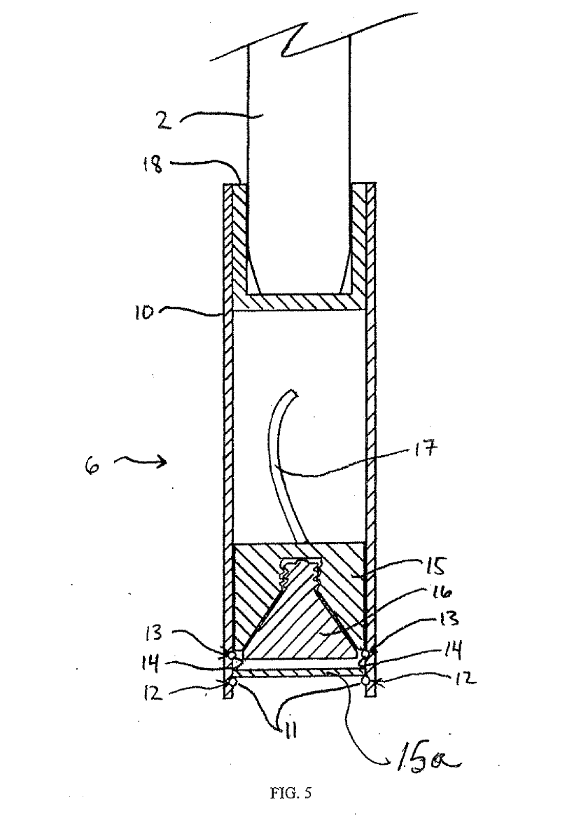

Referring specifically to FIG. 5, there is depicted the lighting assembly 6 in cross sectional representation (the candle 2 is shown only partially). The lighting assembly 6 includes a receptacle 10, a candle holder 18, an electric light fixture 15, an electric light lamp 16, and one candle 2. The receptacle 10 forms a central structure of each lighting assembly 6 and can be made from tubular metal, such as steel or aluminum. Alternatively, the receptacle 10 may be made from glass, plastic, fiber material, wood, or other materials. The receptacle 10 accepts the candle holder 18 in a press fit arrangement although other attachment means are possible such as adhesively bonding, threaded fasteners, rivets, etc. In this aspect, the candle holder 18 accepts the candle 2 just as any normal candle holder does, although other arrangements are possible, such as by loose fit, upwards and vertically oriented pin or spike, with or without a wax drip tray, etc.

The receptacle 10 also co-axially accepts the electric light fixture 15 in a loose fit arrangement, by example only. The electric light fixture 15 is held vertically in place by means of a split ring 14 that expands into a groove 13 cut into the receptacle 10. The electric light fixture 15 accepts the lamp 16 typically by a threaded attachment means typical of most light bulbs. The receptacle 10 may also be configured so that the electric lighting fixture 15 is non-co-axially spaced for offset from the candleholder 18. Additionally, the electric light fixture 15 has an electrical connection means shown as an insulated wire 17. Other design configurations are possible such as electrical connections by battery power or low voltage supply. Additionally, other types of electric light lamps other types of connection means such as double prong, snap fit, bayonet, etc, can be used. There are also many different types of attachment means between the electric lightening means 15 and the enclosure 10 including press fit, adhesively mounted, threaded fasteners, rivets, set screws, etc.

The receptacle 10 or the light fixture 15 can also be fitted with an optional protective lens 15 made typically of glass, although other transparent or colored materials can be employed. The protective lens 15 is retained vertically to the enclosure 10 by means of a split ring 11 that expands into a groove 12 similarly to the retention means for the electric light fixture 15 in the receptacle 10. Other retention means are also possible, including press fit, threaded means, set screws, etc.

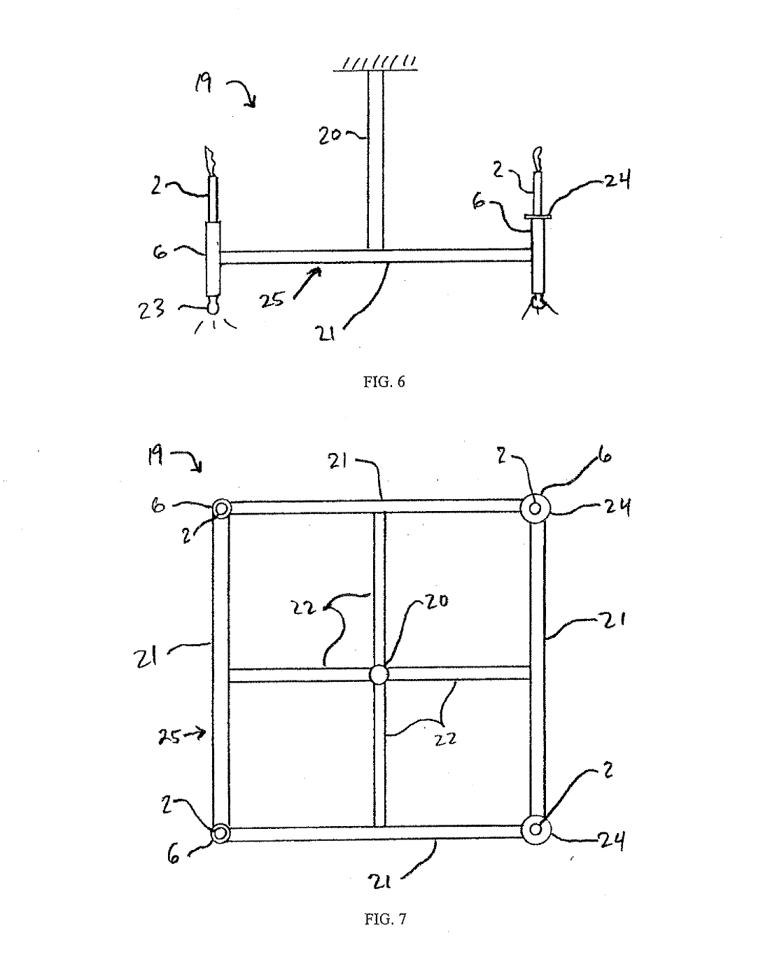

Referring to FIGS. 5 and to FIGS. 6-9, there is depicted another chandelier 19 including the lighting assembly 6 with both electric lighting means 23 and candlesticks 2.

It will be understood that though FIGS. 6-9 depict a chandelier 19 with a particular geometry, construction, and with integrated assemblies that include both the receptacle for the electric light fixture 15 and the candlestick holder 18, there are many different geometries and construction means can be employed. These include, but are not limited to, a variety of different sizes of candlestick holders, a different number of candlestick holders, candlestick holders that are not integrated to the electric light fixture, other flame generating devices such as liquid or gas fuel devices, a variety of different mounting and suspension means including the ability to raise and lower the lighting fixture, different numbers of electric light fixtures including the option for a single lamp, externally mounted light fixtures, and different types of electric light electric light fixtures such as halogen, incandescent, fluorescent, LED, spot style lamps, flood style lamps, etc. Additionally, there are many different materials that may be used to manufacture the components of the chandelier 19.

As shown in FIGS. 6-9, a main frame 25 comprises a non-circular, generally square outer frame 21 and a plurality of inner cross braces 22 that are substantially perpendicular to one another and are attached to each other, to a support 20, and to the outer frame 21. Additionally, there is a support 20 for affixing the chandelier 19 to a mounting means (not shown) that would typically be attached to the ceiling surface of a room. The support 20 positions the chandelier 19 in a vertical position in suspension over the area which is to be illuminated.

In this aspect, the components are fabricated from tubular steel so as to provide an inner cavity (not shown) through which the electrical wires for the electric light means are routed. Alternately, the support 20 can be formed of a flexible cable, chain or rope, or a combination of rigid and flexible members. One affixing means to rigidly connect these components is welding, although there are others possible such as threaded fasteners, rivets, adhesives, etc. Other configurations of the main frame 25 and the support 20 are possible including different geometries, sizes, solid materials with external wires, and different material types including various plastics, wood, fiber materials, glass, etc. This aspect, by example only, shows a second geometry though others are possible such as oval, elliptical, curvilinear, linear, free form shapes, etc.

Attached to and integral with the outer frame 21 are one or a multiplicity of lighting assemblies 6. Although in this aspect, the individual components of the outer frame 21 and the lighting fixture assemblies 6 are affixed by welding, other attachment means are possible including threaded fasteners, rivets, adhesives, etc. Each lighting assembly 6 includes the electric lighting socket 15 and a light bulb 16 and the holder 18 for receiving and supporting a candle 2.

This aspect employs the same lighting assembly 6 depicted in FIG. 5 and described above. Additionally, FIGS. 6-9 illustrate optional features such as an alternative electric lamp 23 design such as a bulb style lamp. Also, the lighting fixture assembly 6 shows an optional wax drip or collection tray 24 carried on the lighting assembly 6 and extending outward from the candleholder 18. The wax collection tray 24 is substantially round although many different shapes, sizes, and configurations are possible, such as oval, elliptical, polygonal, curvilinear, free form shapes, concave configurations, etc.

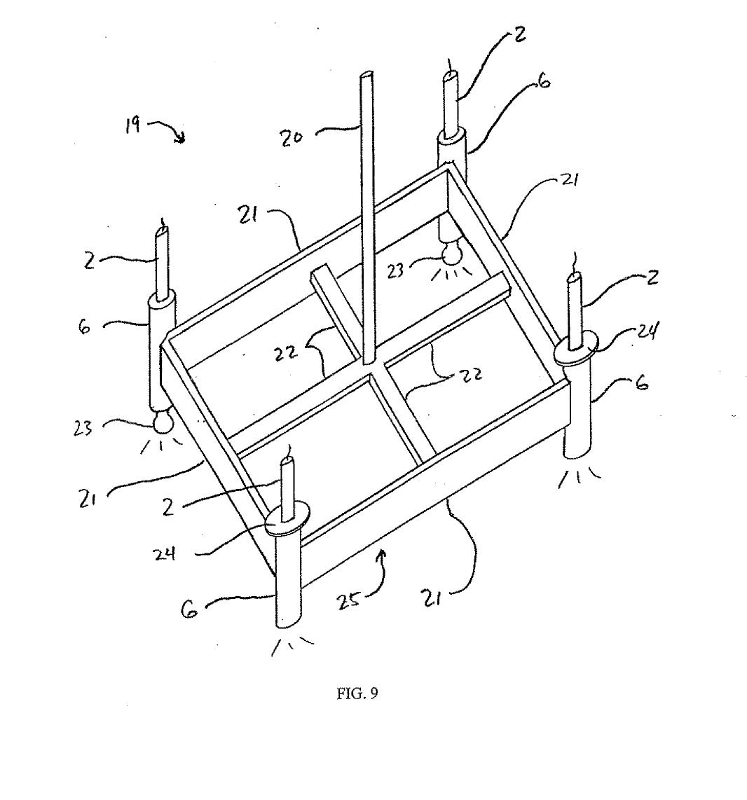

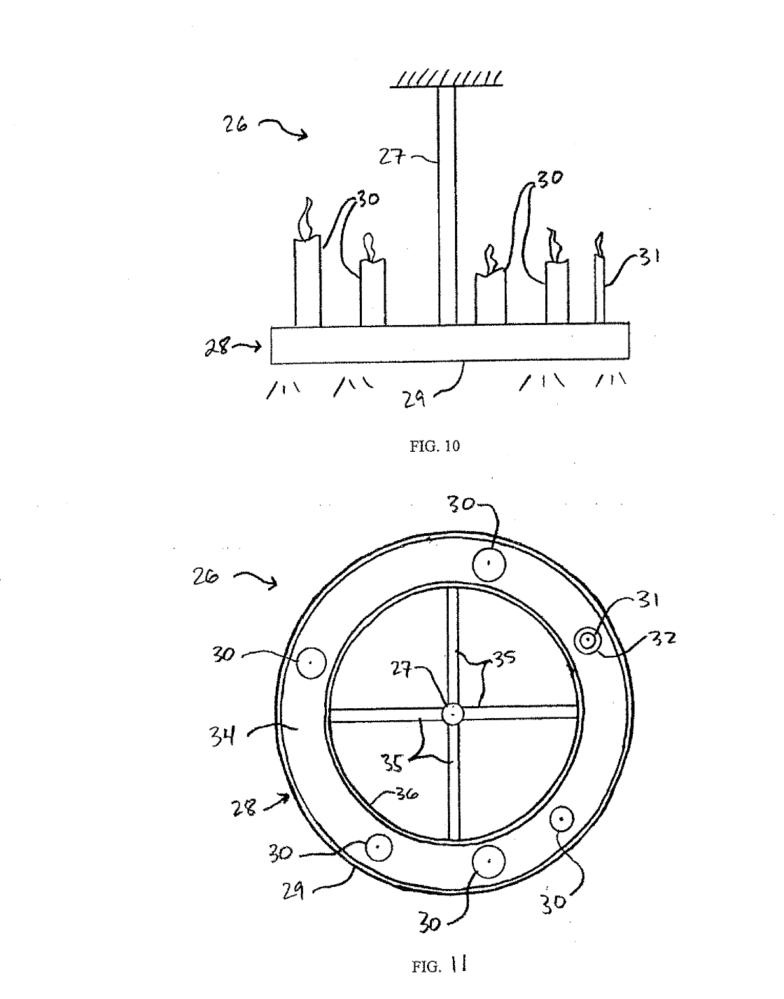

Referring now to FIGS. 10-13, there is depicted another aspect of a chandelier 26 having a frame for both electric lighting means 33 and a shield 34 intended to hold free standing candles 30 as well as optional candle holders 32 which hold candles 31 that require a candle holder 32.

It will be understood that though FIGS. 10-13 depict a chandelier 26 with a particular geometry, construction, and with integrated electric light fixtures 33 there are many different geometries and construction means that can be employed. These include, but are not limited to, a variety of different sizes of candlestick holders 32, different number of candlestick holders 32, candlestick holders 32 that are or are not integrated to the chandelier 26, other flame generating devices such as liquid or gas fuel devices, a variety of different mounting and suspension means including the ability to raise and lower the lighting fixture, different numbers of electric light fixtures including the option for a single lamp, and different types of electric light fixtures such as halogen, incandescent, fluorescent, LED, spot style lamps, flood style lamps. Additionally, there are many different materials that may be used to manufacture the components of the chandelier 26.

As shown in FIGS. 10-13, a main frame assembly 28 includes a generally circular outer frame 29 and a plurality of inner cross braces 35 that are substantially perpendicular to one another and attached to each other, and to a support 27, and to the outer frame 29. The support 27 affixes the chandelier 26 to a mounting means (not shown) that would typically be attached to the ceiling surface of a room is affixed to the inner cross braces 35. The support 27 positions the chandelier 26 in a vertical position in suspension over the area which is to be illuminated.

In this aspect the inner cross braces 35 and the support 27 are fabricated from tubular steel so as to provide an inner cavity (not shown) through which the electrical wires for the electric light means are routed. One affixing means to rigidly connect these components is welding although there are others possible, such as threaded fasteners, rivets, adhesives, and others. The main frame assembly 28 is constructed of the outer frame 29, an inner frame 36, a top plate or shelf 34, a bottom plate 37, and one or a multiplicity of electric lighting fixtures 33. This configuration employs steel as the material for the outer frame 29, the inner frame 36, the top plate or shelf 34, and the bottom plate 37. Other material options exist such as wood, plastic, fiber material, glass, etc., can also be employed. Other configurations of the main frame 25 and the support column 20 are possible including different geometries, sizes, solid materials with external wires, and other shapes such as oval, elliptical, polygonal, curvilinear, linear, free form shapes, etc.

Attached to and integral with the main frame assembly 28 are one or a multiplicity of electric lighting fixtures 33. Many different types of lighting fixtures and lamps are possible as discussed above. Also many different types of attachment and mounting means for the electric lighting fixtures 33 are also possible including fixtures that are externally mounted.

The tray or shelf 34 provides a surface onto which free standing candles 30 or candlestick holders 32 may be placed. The candlestick holders 32 may be integral to and/or mounted permanently or semi-permanently to the shelf 34. Additionally, the shelf 34 may employ wax collection trays (not shown) as described above. The shelf 34 in this aspect is made from steel. Other materials are possible such as plastic, wood, fiber material, glass, etc. Additionally, the shelf 34 may be transparent, translucent, or colored so as to provide a view of the candles from below or to alter the mood and/or color of the light. The shelf 34 may also be removable so as to improve the convenience of cleaning it for wax drippings, dust, or other items.

It will also be understood that the shelf 34 can be used only to support the candles 2 and the light fixtures 33 may be supported by other frame elements separate from the shelf 34, connected to the shelf 34, or connected to the support 27.

Referring to FIGS. 14-18, there is depicted a wall mount lighting fixture 37 with a lighting fixture assembly 6 with both electric lighting means 15 and 16 and holders for candlesticks 2.

It will be understood that although FIGS. 14-18 describe a wall mount lighting fixture 37 with a particular geometry, construction, and with integrated assemblies that include both the lighting assembly 6 having an electric lighting means 15, as described above, and a candlestick holder 18, also described above, other different geometries and construction means are possible. These include, but are not limited to, a variety of different sizes of candlestick holders, different number of candlestick holders, candlestick holders that are not integrated to the electric light fixture, other flame generating devices such as liquid or gas fuel devices, a variety of different mounting and suspension means including the ability to raise and lower the lighting fixture, different numbers of electric light fixtures including the option for multiple lamps, externally mounted lighting fixtures and different types of electric light fixtures such as halogen, incandescent, fluorescent, LED, spot style lamps, flood style lamps, etc. Additionally, there are many different materials that may be used to manufacture the components of the wall mount lighting fixture 37.

As shown in FIGS. 14-18, the lighting assembly 6 is joined to and spaced from a wall mounting plate 38 by means of a support 39. The wall mounting plate 38 is substantially rectangular, but may be of any shape, size, or three-dimensional configuration. The support 39 is made from tubular steel so as to provide for an internal routing of the electric wires that supply power to the electric light fixture 15. One affixing means to rigidly connect the support 39 and the plate 38 is welding though there are others possible such as threaded fasteners, rivets, adhesives, etc. Other configurations are possible including different geometries, sizes, solid materials with external wires, and different material types including various plastics, wood, fiber materials, glass, and others.

This aspect employs the same lighting assembly 6 depicted in FIG. 5 and described above. Additionally, FIGS. 14-18 illustrate additional optional features such as the wax collection tray 24. This wax collection tray 24 is substantially round, although other different shapes, sizes, and configurations are possible such as oval, elliptical, polygonal, curvilinear, free form shapes, concave configurations, etc. As in previous aspects, many different types of electric lamps can be used.

What is claimed is:

1. A lighting apparatus comprising:
a support;
a candleholder coupled to the support; and
an electrically powered light fixture coupled to the support.

2. The lighting apparatus of claim 1 wherein the support further comprises:
a frame, at least one of a candleholder and an electrically powered light fixture coupled to the frame.

3. The lighting apparatus of claim 2 wherein:
the frame has one of a circular, polygonal, non-circular and non-polygonal shape.

4. The lighting apparatus of claim 2 wherein the frame comprises:
an outer member; and
an inner member coupled to the outer member and to the support.

5. The lighting apparatus of claim 2 further comprising:
a shelf, coupled to the frame, adapted to support a candle.

6. The lighting apparatus of claim 1 further comprising:
a shelf coupled to the support, adapted to support a candle.

7. The lighting apparatus of claim 1 further comprising:
a wax collection tray associated with the candleholder.

8. The lighting apparatus of claim 1 further comprising:
a receptacle affixing the candleholder and the light fixture.

9. The lighting apparatus of claim 8 wherein:
the receptacle coaxially affixes the candleholder and the light fixture.

10. A lighting apparatus comprising:
a support;
a shelf, coupled to the support, adapted for carrying a candle; and
an electrically powered light fixture coupled to one of the shelf and the support.

11. The lighting apparatus of claim 10 further comprising:
a candleholder carried by the shelf.

12. The lighting apparatus of claim 11 further comprising:
a wax collection tray associated with the candleholder.

13. The lighting apparatus of claim 10 the support further comprising:
a frame, at least one of a candleholder and a light fixture coupled to the frame.

14. The lighting apparatus of claim 13 wherein:
the frame has one of a circular, polygonal, non-circular and non-polygonal shape.

15. The lighting apparatus of claim 13 wherein the frame comprises:
an outer member; and
an inner member coupled to the outer member and to the support.

16. A lighting apparatus comprising:
a support;
a frame coupled to the support;
a shelf, coupled to one of the frame and the support, adapted for carrying a candle; and
an electrically power light fixture coupled to one of the shelf and the frame.

17. The lighting apparatus of claim 11 further comprising:
a candleholder coupled to one of the shelf and the frame.

18. The lighting apparatus of claim 17 further comprising:
a wax collection tray associated with the candleholder.

19. The lighting apparatus of claim 16 further wherein:
the frame has one of a circular, polygonal, non-circular and non-polygonal shape.

20. A lighting apparatus comprising:
a support;
a frame coupled to the support;
a candleholder coupled to one of the support and the frame; and
an electrically powered light fixture coupled to the other of the support and the frame.
